(19) United States
(12) Patent Application Publication
(10) Pub. No.: US 2026/0312336 A1
(43) Pub. Date: Oct. 8, 2026

(54) CONNECTOR

(71) Applicant: Japan Aviation Electronics Industry, Limited, Tokyo (JP)

(72) Inventor: Takashi OMODACHI, Tokyo (JP)

(21) Appl. No.: 19/478,563

(22) PCT Filed: Dec. 27, 2023
(86) PCT No.: PCT/JP2023/047036

§ 371 Date: Oct. 24, 2025

(30) Foreign Application Priority Data
Jun. 26, 2023 (JP) 2023-104514
Jun. 26, 2023 (JP) 2023-104515

(51) Int. Cl. H01R 13/627; H01R 12/71; H01R 13/50; H01R 13/635; H01R 43/26

(52) U.S. Cl. CPC H01R 13/6275; H01R 13/50; H01R 13/635; H01R 12/71; H01R 43/26

(57) ABSTRACT

A locking mechanism provided in a connector includes a spring portion, an extension portion, a locking portion, an operating portion, and a pressing load receiving portion. The pressing load receiving portion is provided on an inner side of the connector at the extension portion. Each of two island portions provided in a housing constituting the connector includes two pressing load portions. The pressing load receiving portion faces a corresponding one of the two pressing load portions, the pressing load receiving portion comes into contact with the corresponding one of the two pressing load portions when the operating portion is in a non-release position, and the pressing load receiving portion separates from the corresponding one of the two pressing load portions when the operating portion is in a release position.

### TECHNICAL FIELD

The present invention relates to a connector.

### BACKGROUND ART

Conventionally, there is known a connector that, by moving a mating connector in a third direction (for example, an up-down direction) orthogonal to a virtual plane formed by a first direction (for example, a left-right direction) and a second direction (for example, a front-rear direction) that are orthogonal to each other, is fitted with or removed from the mating connector.

Some connectors of this type include a locking mechanism that holds a fitted state between the mating connector and the connector.

For example, Patent Literature 1 listed below discloses a connector including a locking mechanism as shown in FIG. 31. That is, a connector (100) disclosed in Patent Literature 1 includes a total of four restriction mechanisms (500) provided two by two in each of two additional members (400) in the connector (100). Each of the four restriction mechanisms (500) includes a plate-like spring member having a U-shape, a protrusion (511) as a locking portion is formed on a root side of the spring member that is elastically deformable, and an operating portion (550) is formed on a leading end side of the spring member. When an operator operates an operating portion (550) formed on a leading end side of the spring, the protrusion (511) formed on the root side of the spring can be moved. In other words, the protrusion (511) is engaged with the mating connector to hold a fitted state between the connectors, and the protrusion (511) separates from the mating connector to release the fitted state between the connectors. Note that the symbols described in citation list are in parentheses to distinguish from those in an embodiment of the present invention.

### CITATION LIST

### Patent Literature

Patent Literature 1: Japanese Patent Laid-Open No. 2018-181824

### SUMMARY OF INVENTION

### Technical Problem

However, the restriction mechanism (500) as a spring member provided in the connector disclosed in Patent Literature 1 is a member that is generally formed by punching and press processing of a metal plate, for example. In the press processing, it is difficult to control an opening dimension on a leading end side of the restriction mechanism (500), as a plate-like spring member having an U-shape, with high accuracy, and there is a problem that variations in the opening dimension of the spring member inevitably occur during manufacturing. The plate-like spring member having the U-shape includes an operating portion (550) operated by an operator and a protrusion (511) as a locking portion, and the variation in the opening dimension of the spring member means variations in the position of these portions in the connector. In particular, in the connector of Patent Literature 1, there is a large variation in the position of the operating portion (550) provided on the leading end side of the spring member.

Accordingly, the present invention aims to provide a connector equipped with a mechanism including a plate-like spring member having an U-shape, and an operating portion and a locking portion connected to the spring member, thereby eliminating variations in an opening dimension of the plate-like spring member having the U-shape and having no variation in position of the operating portion and the locking portion.

### Solution to Problem

A connector according to the present invention is a connector that, by moving a mating connector in a third direction orthogonal to a virtual plane formed by a first direction and a second direction that are orthogonal to each other, is fitted with or removed from the mating connector, in which: the connector includes a housing, a plurality of terminals, and two additional members; the housing includes a terminal holding portion and two island portions; the plurality of terminals are held in the terminal holding portion and arranged in the first direction in the housing; the two additional members are held in the housing and located at both ends of the housing in the first direction; each of the two additional members includes two locking mechanisms located to face each other in the second direction; each of the two locking mechanisms includes a spring portion, an extension portion, a locking portion, an operating portion, and a pressing load receiving portion; the spring portion is a plate-like elastic member having an U-shape that is closed on one side of an outer side and an inner side of the connector and open on the other side of the outer side and the inner side thereof in the first direction when viewed in the third direction, an end of the U-shape on the outer side of the connector in the second direction being formed as a fixed end, an end of the U-shape on the inner side of the connector in the second direction being formed as a free end; the extension portion is formed to be continuous with the end on the inner side of the connector in the second direction, which is formed as the free end of the spring portion having the U-shape, and to extend in the first direction, and is capable of being displaced in the second direction by an elastic force of the spring portion; the locking portion is formed on the inner side of the connector in the second direction of the extension portion, and includes a locking surface that faces one side in the third direction; the operating portion is formed on the outer side of the connector than the locking portion in the first direction of the extension portion, and on the inner side of the connector in the second direction of the extension portion; the operating portion is movable between a non-release position, and a release position that, when a pressing operation toward the outer side of the connector in the second direction is undergone, is located closer to the outer side of the connector than the non-release position in the second direction; the pressing load receiving portion is provided on the inner side of the connector in the second direction of the extension portion, at a position between the locking portion and the operating portion in the first direction of the extension portion; each of the two island portions includes a total of two pressing load portions facing away from each other toward the outer side of the connector in the second direction; each of the pressing load receiving portions faces a corresponding one of the pressing load portions in the second direction; when the operating portion is in the non-release position, each of the pressing load receiving portions comes into contact with the corresponding pressing load portion, and receives a pressing load toward the outer side of the connector in the second direction; and when the operating portion is in the release position, each of the pressing load receiving portions separates from the corresponding pressing load portion.

In other words, the connector according to the present invention is configured in which the pressing load portion is provided in the housing, the pressurized addition portion is provided in the extension portion which is continuous with the spring portion as the plate-like elastic member having the U-shape and includes the locking portion and the operating portion, and the pressing addition portion constantly contacts and presses the pressurized addition portion to apply a preload when the unlocking operation is not performed (that is, when the operating portion is in the non-release position). Thus, the opening of the spring when the operating portion is in the non-release position is determined by the pressing addition portion rather than the natural state of the member, and the positions of the locking portion and the operating portion are always defined in predetermined positions by the pressing load portion provided in the housing.

### Advantageous Effects of Invention

According to the present invention, it is possible to provide a connector in which variations in an opening dimension is eliminated that occurs during manufacturing of a plate-like spring member having an U-shape (including a spring portion as an elastic member and an extension portion), which is a component of a locking mechanism responsible for holding and releasing a fitted state between connectors, and positions of a locking portion and an operating portion connected to the spring member are defined without variations.

### BRIEF DESCRIPTION OF DRAWINGS

FIG. 1 is an upper perspective view showing a connector and a mating connector of the present embodiment.

FIG. 2 is a top view showing the connector and the mating connector in FIG. 1.

FIG. 3 is a bottom view showing the connector and the mating connector in FIG. 1.

FIG. 4 is a front view showing the connector and the mating connector in FIG. 1.

FIG. 5 is a right side view showing the connector and the mating connector in FIG. 1.

FIG. 6 is a cross-sectional view showing the connector and the mating connector in FIG. 2, taken along line 6-6.

FIG. 7 is a cross-sectional view showing the connector and the mating connector in FIG. 4, taken along line 7-7.

FIG. 8 is an upper perspective view showing a state in which the mating connector is removed from the connector of the present embodiment.

FIG. 9 is a lower perspective view showing the mating connector of the present embodiment.

FIG. 10 is a lower perspective view showing a state in which the mating connector of the present embodiment is exploded.

FIG. 11 is an upper perspective view showing the connector of the present embodiment.

FIG. 12 is an upper perspective view showing a state in which the connector of the present embodiment is exploded.

FIG. 13 is an upper perspective view showing an additional member constituting the connector of the present embodiment.

FIG. 14 is a lower perspective view showing the additional member constituting the connector of the present embodiment.

FIG. 15 is a top view showing the additional member constituting the connector of the present embodiment.

FIG. 16 is a bottom view showing the additional member constituting the connector of the present embodiment.

FIG. 17 is a front view showing the additional member constituting the connector of the present embodiment.

FIG. 18 is a cross-sectional view showing the additional member in FIG. 17, taken along line 18-18.

FIG. 19 is a right side view showing the additional member constituting the connector of the present embodiment.

FIG. 20 is a left side view showing the additional member constituting the connector of the present embodiment.

FIG. 21 is a front view showing the connector of the present embodiment.

FIG. 22 is a cross-sectional view showing the connector in FIG. 21, taken along line 22-22.

FIG. 23 is a cross-sectional view showing a modified example of the connector of the present embodiment shown in FIG. 22. FIG. 23 shows a locking mechanism of the additional member provided on a left side of the connector.

FIG. 24 is a lower perspective view showing an unlocking jig of the present embodiment.

FIG. 25 is a front view for explaining a method of using the unlocking jig of the present embodiment, showing a state before unlocking of a connector assembly. In the drawing, a first circuit board and a second circuit board are indicated by dashed lines.

FIG. 26 is a front view for explaining a method of using the unlocking jig of the present embodiment, showing a state during unlocking of the connector assembly. In the drawing, a first circuit board and a second circuit board are indicated by dashed lines.

FIG. 27 is a right side view for explaining a method of using the unlocking jig of the present embodiment, showing a state during unlocking of the connector assembly.

FIG. 28 is a cross-sectional view showing the connector, the mating connector, and the unlocking jig in FIG. 27, taken along line 28-28.

FIG. 29 is a cross-sectional view showing the connector, the mating connector, and the unlocking jig in FIG. 27, taken along line 29-29.

FIG. 30 is a view for explaining a relationship between the unlocking jig, the connector, and the mating connector of the present embodiment, showing a perspective view of the connector and the mating connector when viewed from above.

FIG. 31 is a cross-sectional view showing an example of a schematic configuration of a connector according to Patent Literature 1.

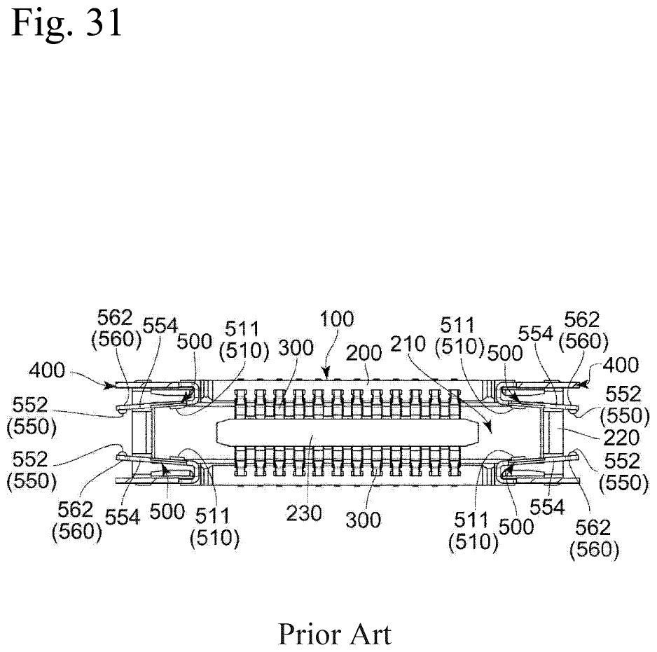

### DESCRIPTION OF EMBODIMENT

Hereinafter, preferred embodiments for carrying out the present invention will be described with reference to the drawings. In the present invention, a first direction, a second direction, and a third direction are defined, and an X direction, a Y direction, and a Z direction are defined in the drawings for convenience of description. In the description, the first direction is a left-right direction. In the drawings, the left-right direction is shown as the X direction. In particular, the right side is defined as +X direction, and the left side is defined as a −X direction. In the description, the second direction is a front-rear direction. In the drawings, the front-rear direction is shown as the Y direction. In particular, the front side is defined as a +Y direction, and the rear side is defined as a −Y direction. In the description, the third direction is an up-down direction. In the drawings, the up-down direction is shown as the Z direction. In particular, the upside is defined as a +Z direction, and the downside is defined as a −Z direction.

Furthermore, the following embodiments do not limit the inventions related to claims, and it cannot be said that the entirety of combinations of characteristics described in the embodiment are essential for the solution to problem.

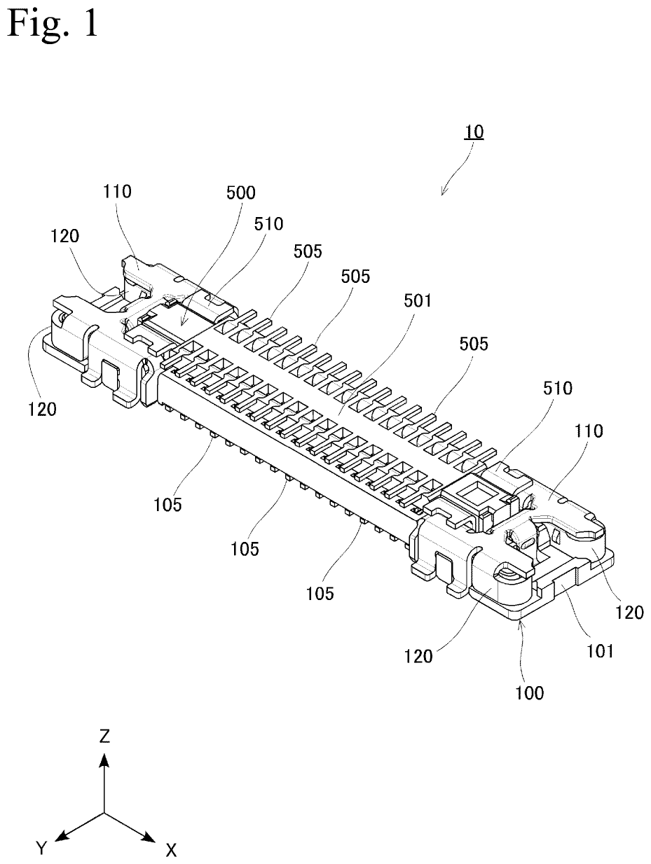

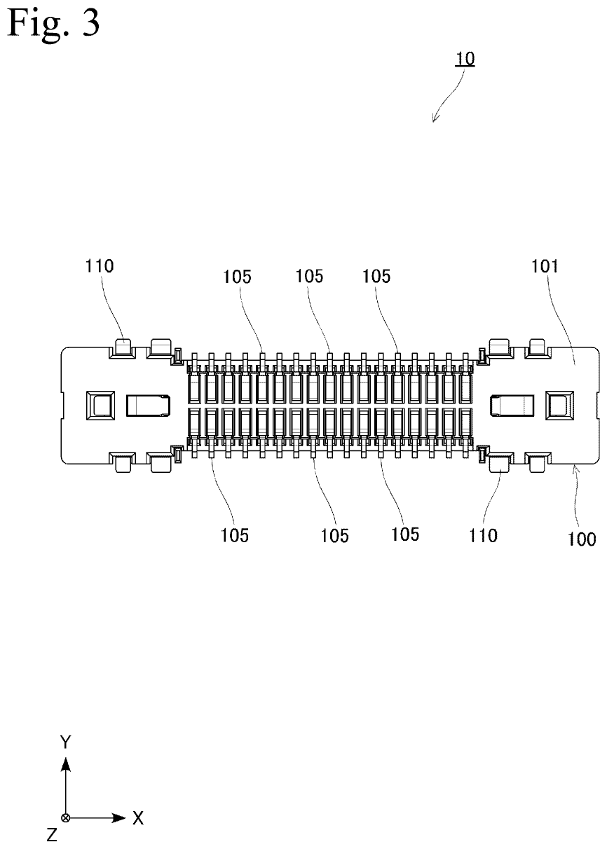

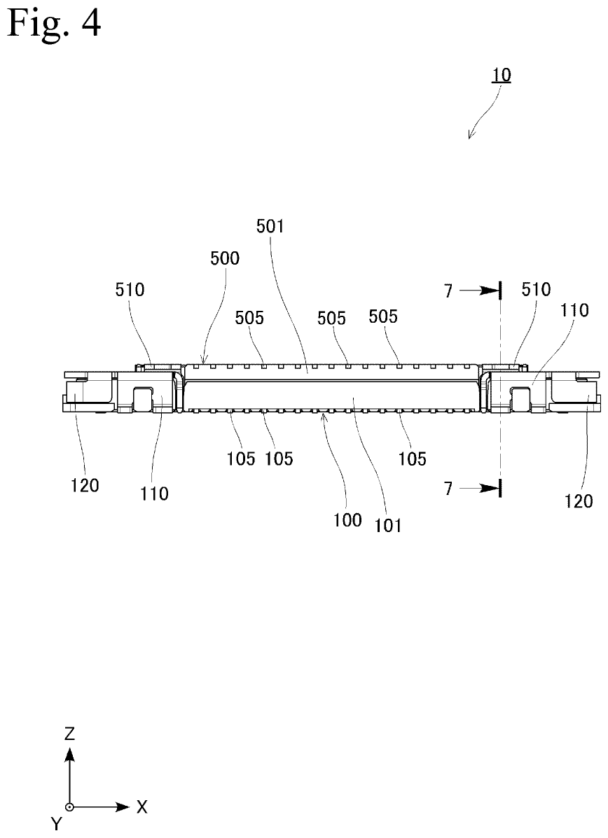

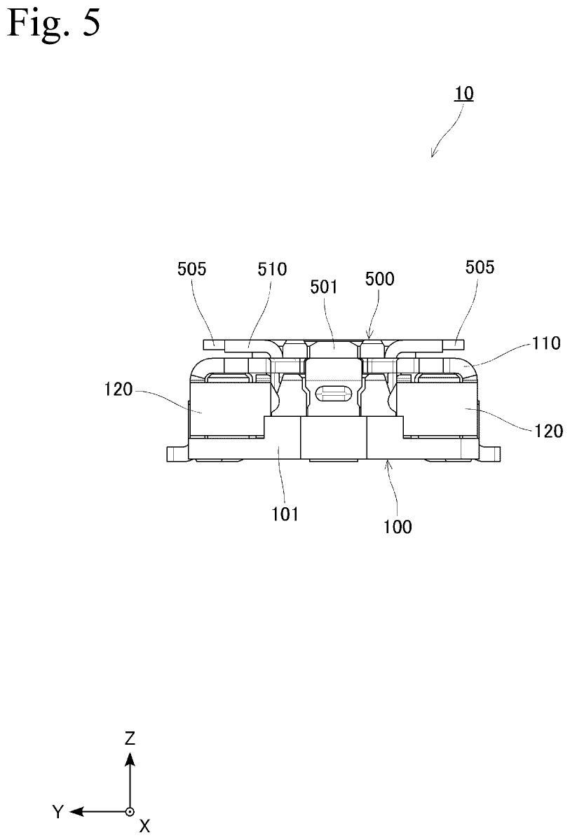

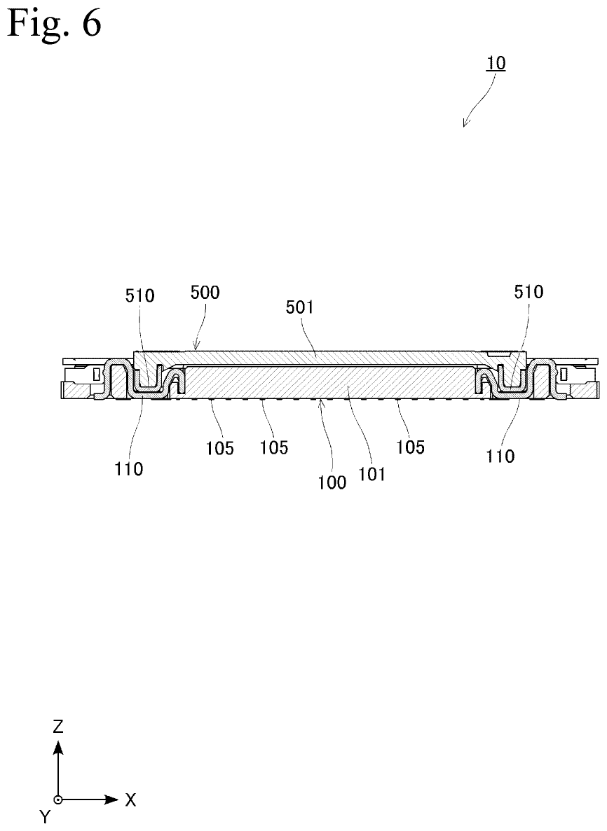

As shown in FIGS. 1 to 7, a connector 100 of the present embodiment constitutes a connector assembly 10 together with a mating connector 500. In the present embodiment, the mating connector 500 is configured as a plug connector, and the connector 100 is configured as a receptacle connector.

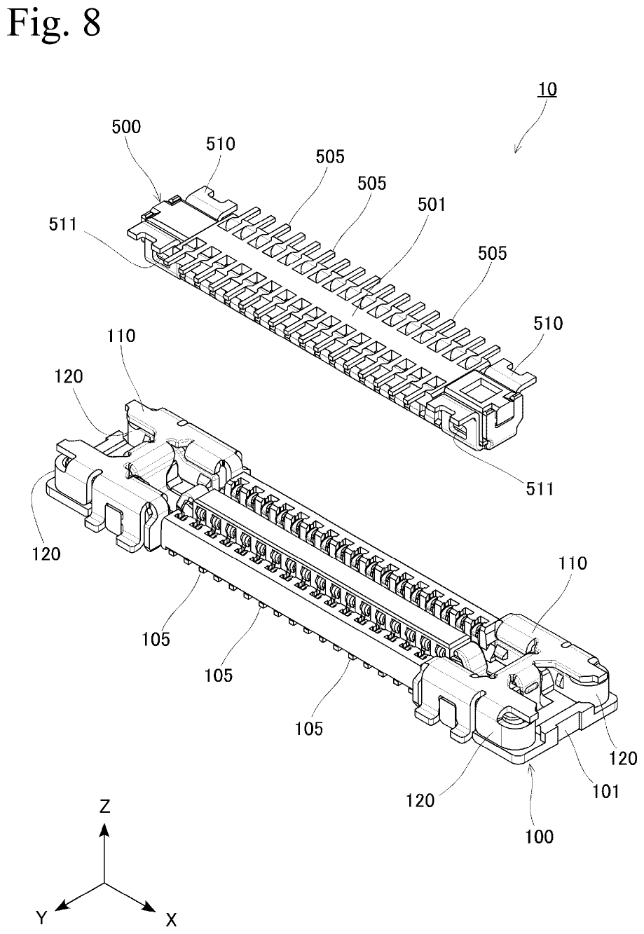

With reference to FIGS. 1 and 8, the connector assembly 10 of the present embodiment is configured such that the mating connector 500 moves in the third direction (Z: up-down direction) orthogonal to a virtual plane formed by the first direction (X: left-right direction) and the second direction (Y: front-rear direction) that are orthogonal to each other, and thus the mating connector 500 is fitted with or removed from the connector 100.

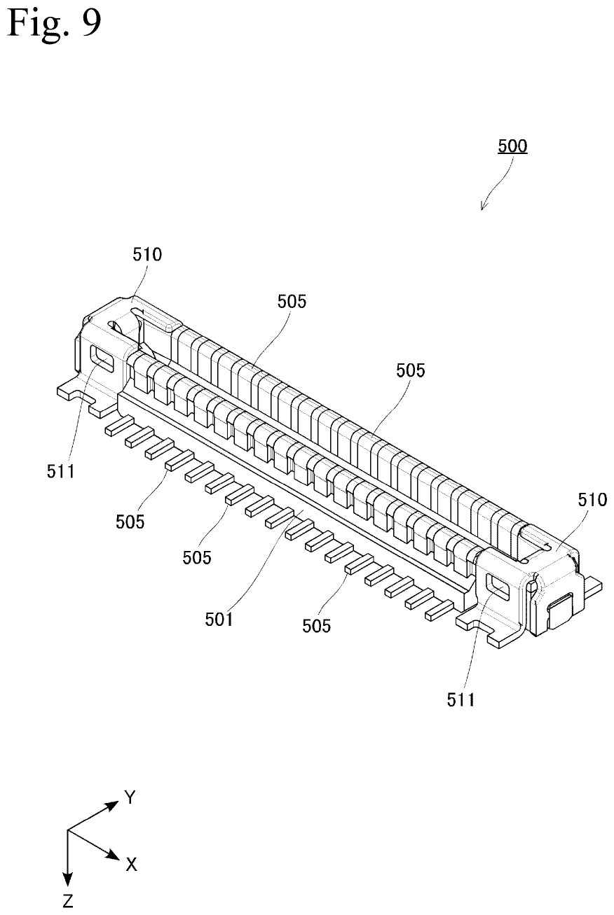

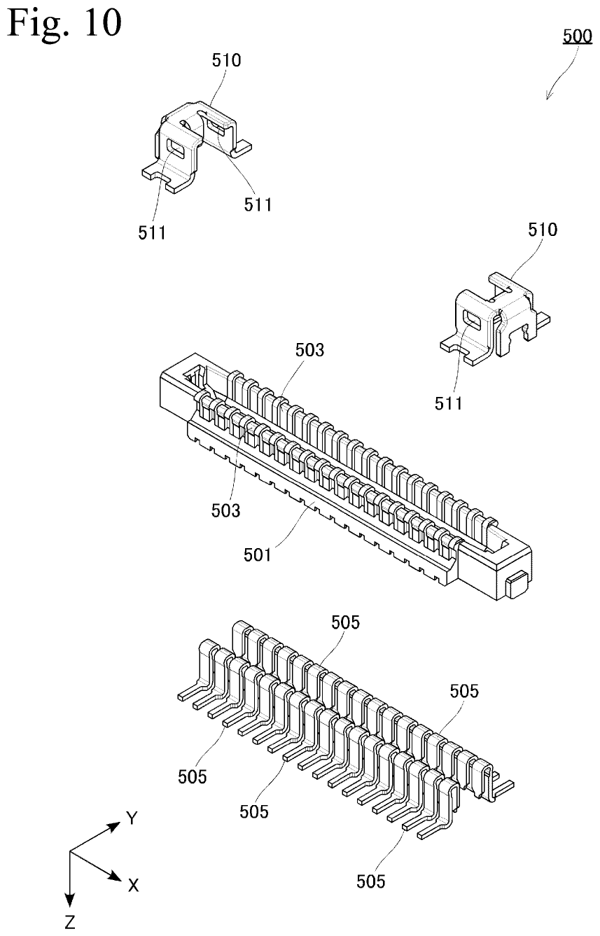

As shown in FIGS. 9 and 10, the mating connector 500 of the present embodiment includes a mating housing 501, a plurality of mating terminals 505, and two mating additional members 510.

The mating housing 501 is a member that functions as an insulator, and is made of a resin material, for example. In addition, the mating housing 501 includes a mating terminal holding portion 503, and a plurality of mating terminals 505 are installed on the mating terminal holding portion 503.

The plurality of mating terminals 505 are members that are made of a conductive metal material and are formed, for example, by punching and press processing of a metal plate. The plurality of mating terminals 505 of the present embodiment are held in the mating terminal holding portion 503 of the mating housing 501 and are arranged in a direction along the left-right direction which is the first direction. The mating housing 501 and the plurality of mating terminals 505 are integrally formed by injection molding, for example.

The two mating additional members 510 are members that are held in the mating housing 501 and are located at both ends of the mating housing 501 in the left-right direction which is the first direction. The two mating additional members 510 of the present embodiment are fitted, from the downside toward the upside (in the +Z direction), into both ends of the housing 501 including the plurality of mating terminals 505 integrally formed by injection molding or the like, and are thus attached to the housing 501. The mating additional members 510 are formed of, for example, a metal material.

Furthermore, each of the two mating additional members 510 of the present embodiment includes locking holes 511 on front and rear surfaces. In other words, the mating connector 500 of the present embodiment includes a total of four locking holes 511 formed one by one on front and rear surfaces of each of left and right ends. These four locking holes 511 are engaged with locking portions 123 of a locking mechanism 120 provided in the connector 100, which will be described below, to achieve a locked state, and are configured to hold a state where the mating connector 500 is fitted with the connector 100.

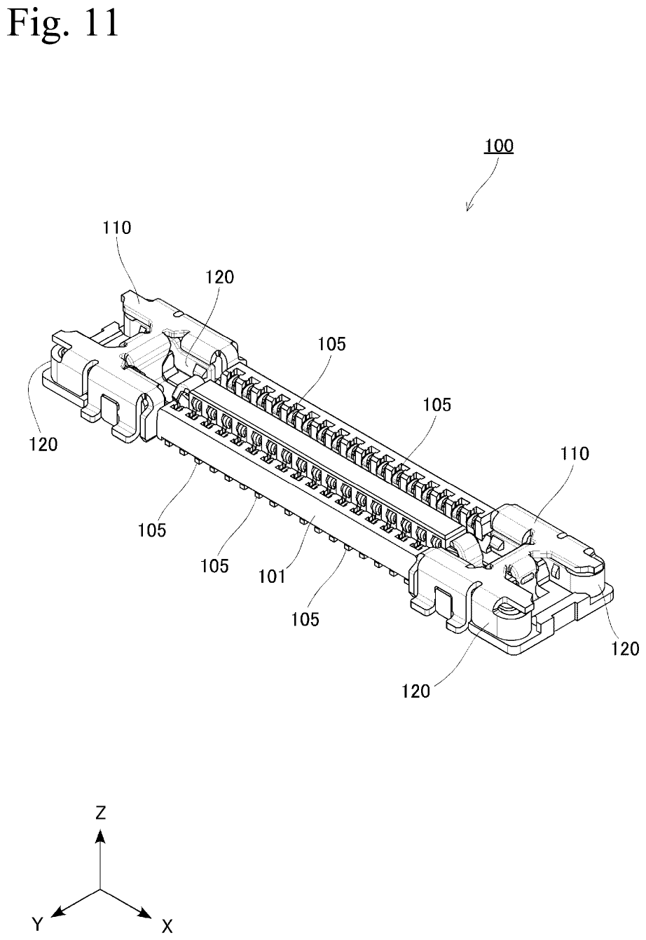

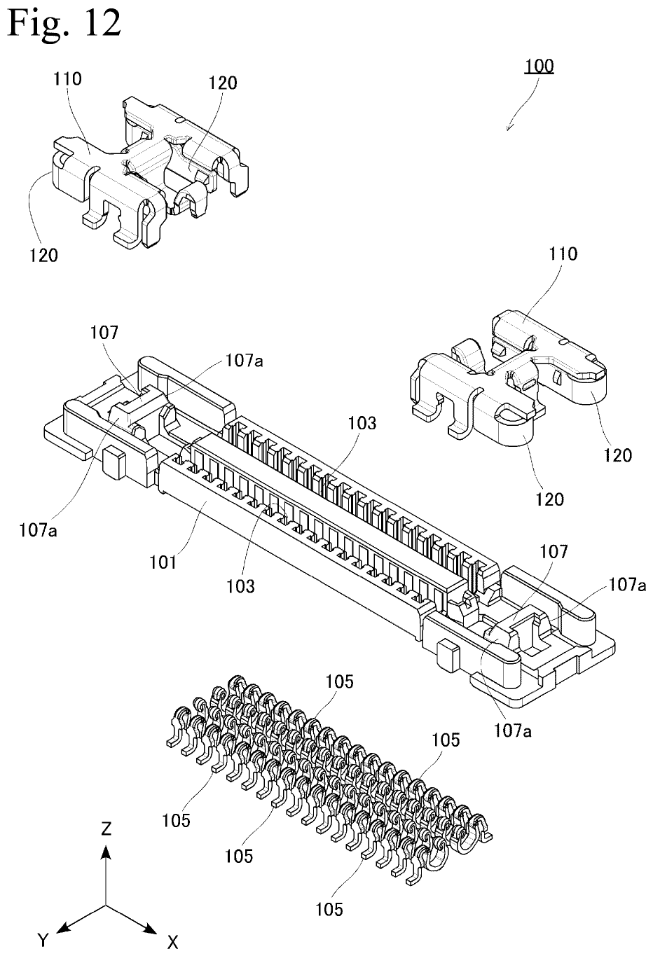

On the other hand, as shown in FIGS. 11 and 12, the connector 100 of the present embodiment includes a housing 101, a plurality of terminals 105, and two additional members 110.

The housing 101 is a member that functions as an insulator, and is made of a resin material, for example. The housing 101 includes a terminal holding portion 103 and two island portions 107. A plurality of terminals 105 are installed on the terminal holding portion 103. On the other hand, the two island portions 107 are formed at position respectively corresponding to two additional members 110 to be described below.

The plurality of terminals 105 are members that are made of a conductive metal material and are formed, for example, by punching and press processing of a metal plate. The plurality of terminals 105 of the present embodiment are held in the terminal holding portion 103 of the housing 101 and are arranged in a direction along the left-right direction which is the first direction. The housing 101 and the plurality of terminals 105 are integrally formed by injection molding, for example. In this case, the terminal holding portion 103 is formed simultaneously with the injection molding, and thus is inseparable from the plurality of terminals 105. However, the housing 101 of the present embodiment may be formed in such a manner that the housing 101 made of a resin material is formed in advance, and the plurality of terminals 105 are fitted into the terminal holding portion 103 formed in advance.

The two additional members 110 are members that are held in the housing 101 and are located at both ends of the housing 101 in the left-right direction which is the first direction. The two additional members 110 of the present embodiment are fitted, from the upside toward the downside (in the −Z direction), into both ends of the housing 101 including the plurality of terminals 105 integrally formed by injection molding or the like, and are thus attached to the housing 101. The two additional members 110 and the two island portions 107 described above overlap each other in the left-right direction (X direction), and more specifically, the positional range of the island portion 107 in the left-right direction (X direction) is within the positional range of the corresponding additional member 110 in the present embodiment. In the present embodiment, each of the additional members 110 includes a recess shape that can cover the corresponding island portion 107, which protrudes upward (in the +Z direction), toward the downside (in the −Z direction) from the upside. In other words, the two additional members 110 are fitted into the portions including the corresponding island portions 107 on both ends of the housing 101, respectively, and are thus attached to the housing 101. The additional members 110 are formed of, for example, a metal material.

Furthermore, each of the two additional members 110 of the present embodiment includes locking mechanisms 120 that are engaged with the four locking hole 511 provided in the mating connector 500 to achieve a locked state. The locking mechanisms 120 are provided two by two for each of the two additional members 110. In other words, the connector 100 includes a total of four locking mechanisms 120 formed two by two on each of left and right ends.

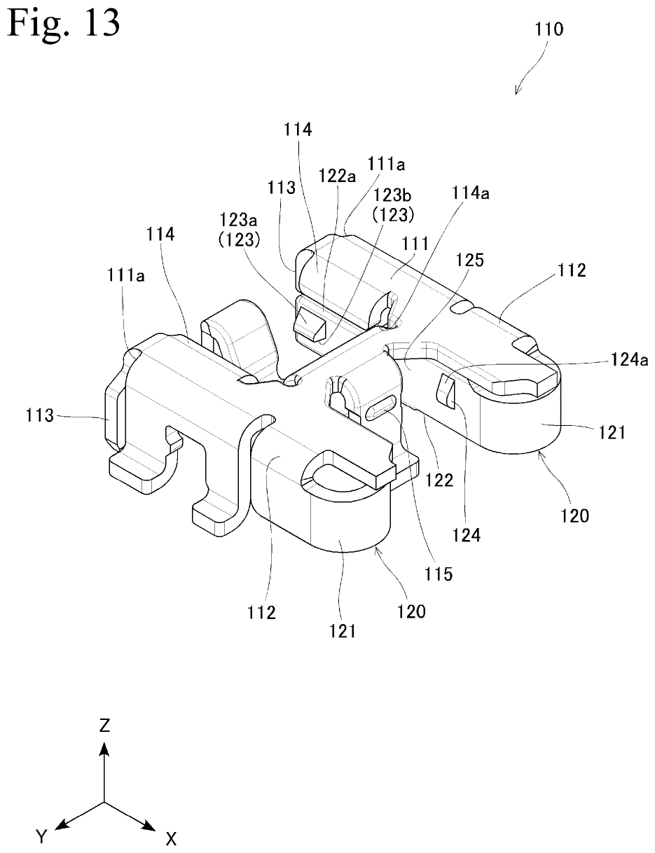

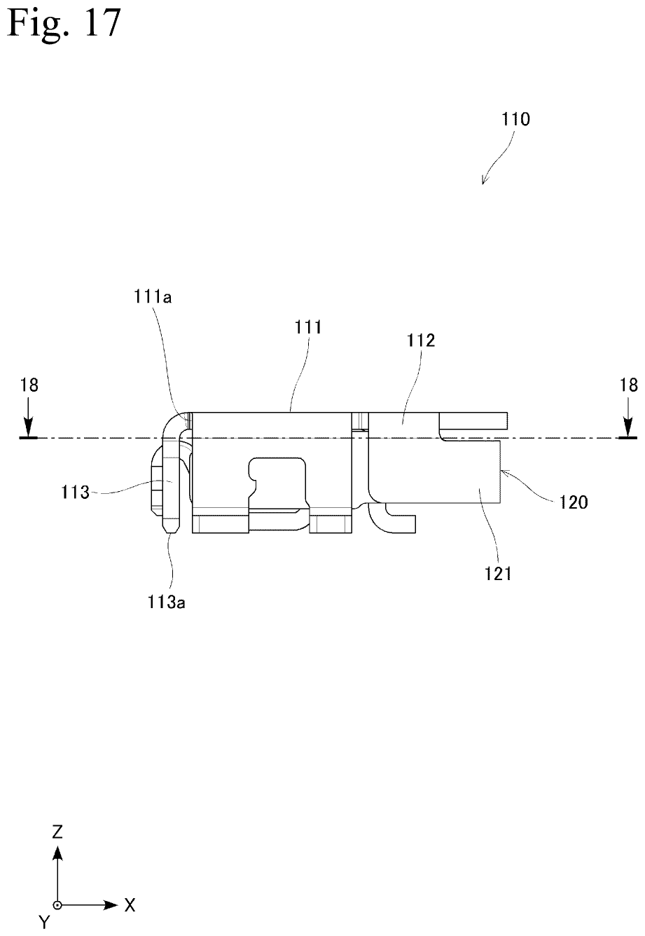

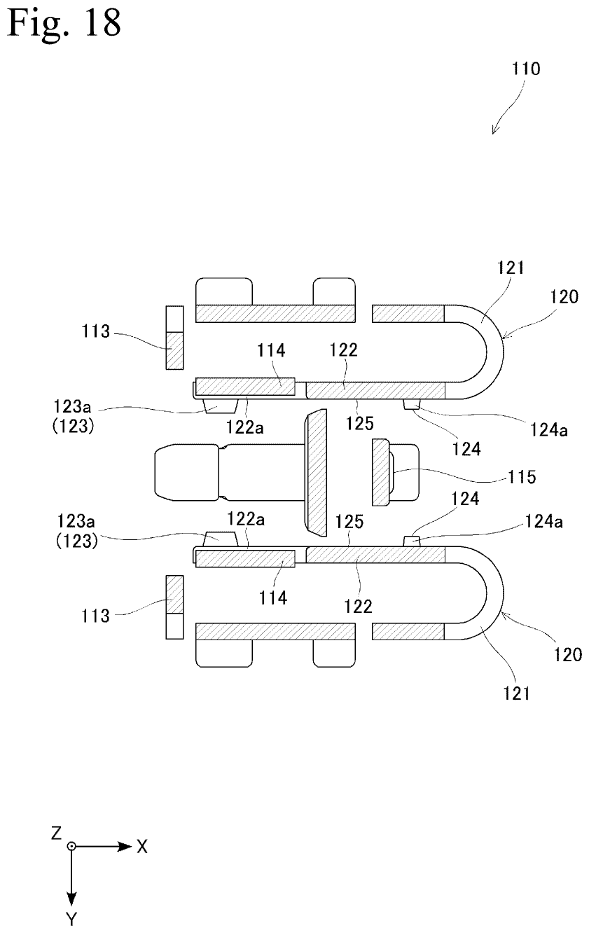

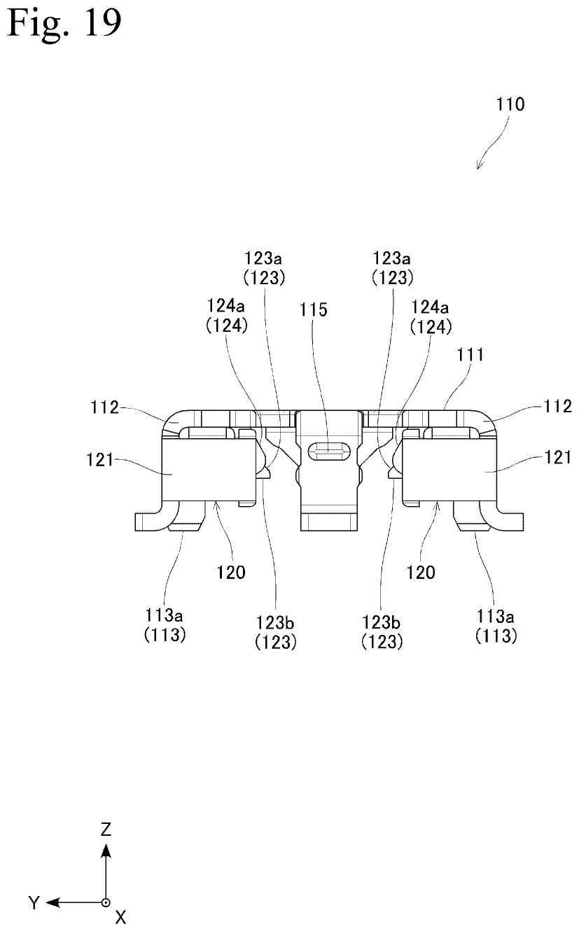

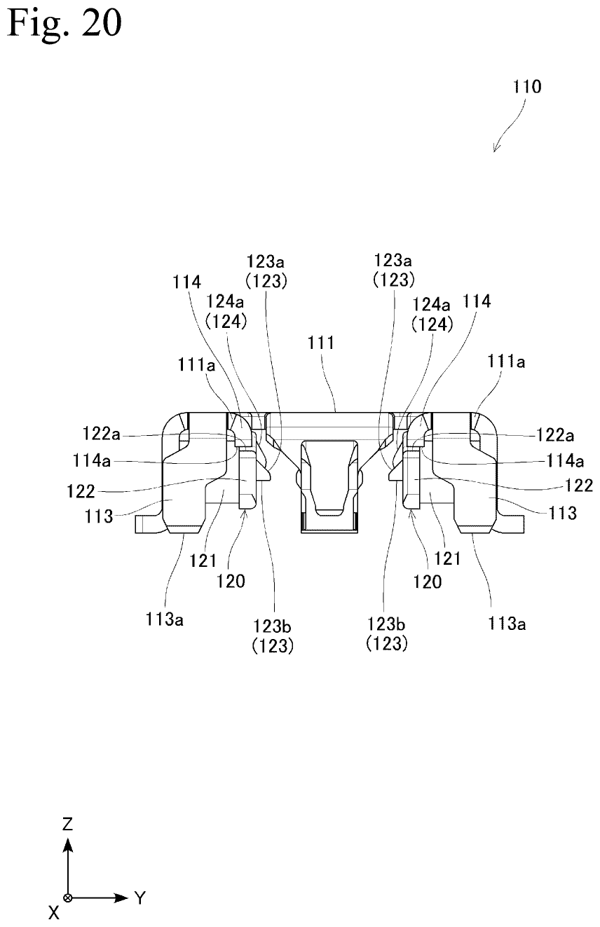

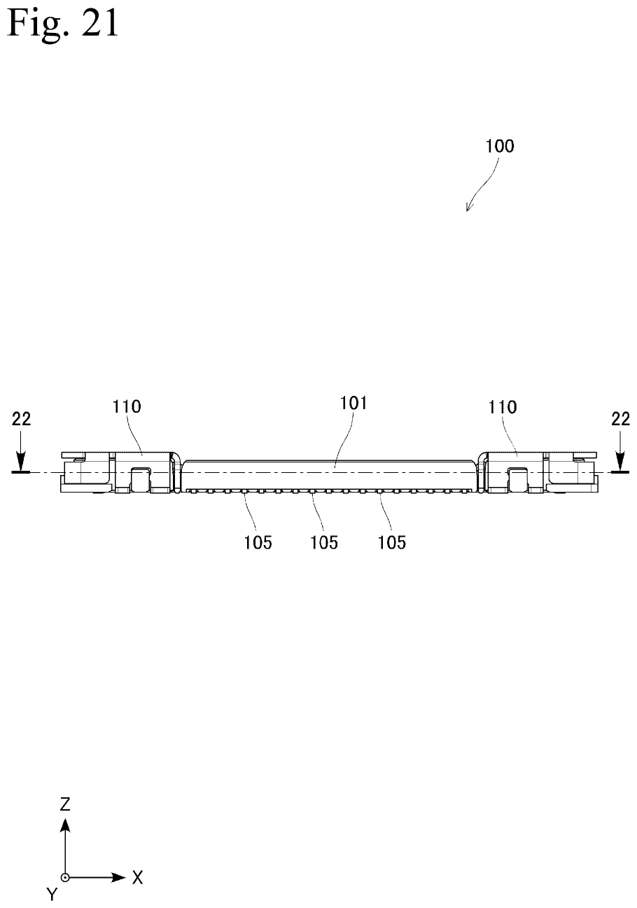

Next, with reference to FIGS. 13 to 22, a description will be made with respect to a detailed configuration of the additional member 110 including the locking mechanisms 120 in the connector 100. FIGS. 13 to 20 show the additional member 110 installed on the right side of the connector 100.

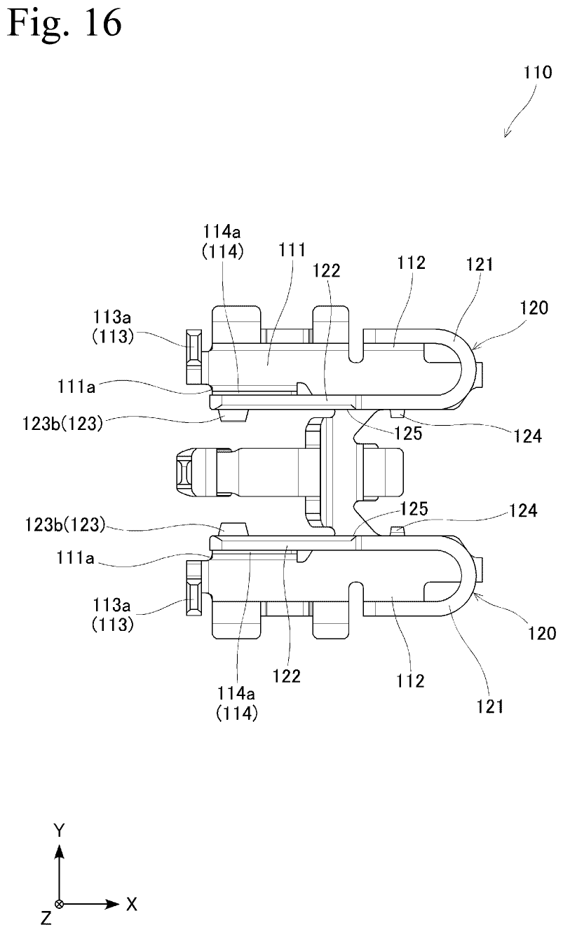

As shown in FIG. 16, the additional member 110 of the present embodiment includes two locking mechanisms 120 that are located to face each other in the front-rear direction, which is the second direction. Each of the two locking mechanisms 120 includes a spring portion 121, an extension portion 122, a locking portion 123, an operating portion 124, and a pressing load receiving portion 125.

In this example, the spring portion 121 is a portion that is formed as a plate-like elastic member having an U-shape that is closed at the outer side of the connector 100 and open at an inner side thereof in the left-right direction, which is the first direction, when viewed in the up-down direction, which is the third direction. The spring portion 121 is configured such that an end of the U-shape on the outer side of the connector 100 in the front-rear direction, which is the second direction, is connected to a portion of the additional member 110 (in this example, a bent portion 112 to be described below) other than the locking mechanism 120 to form a fixed end, and an end of the U-shape on the inner side of the connector 100 in the front-rear direction, which is the second direction, is formed as a free end.

The extension portion 122 is a member that is continuous with the end formed as a free end of the U-shaped spring portion 121 on the inner side of the connector 100 in the front-rear direction, which is the second direction. The extension portion 122 is formed to extend in the left-right direction, which is the first direction, whereby the extension portion 122 can be displaced in the front-rear direction, which is the second direction, by an elastic force of the spring portion 121.

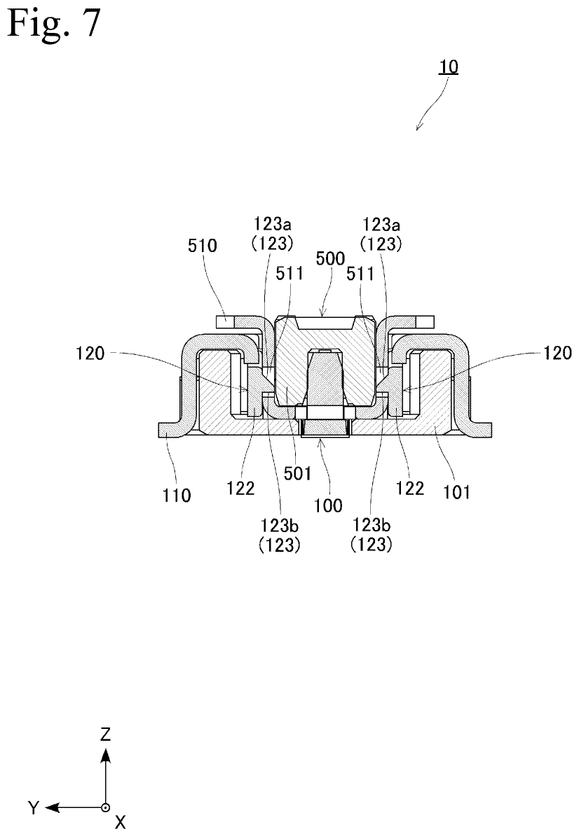

The locking portion 123 is formed on the inner side of the connector 100 in the front-rear direction which is the second direction of the extension portion 122. The locking portion 123 includes an slope 123a formed on the upper side and a locking surface 123b formed on the lower side, which is a flat surface facing downward which is one of the up-down direction which is the third direction, as shown in a cross-sectional shape in FIG. 7. Therefore, when the mating connector 500 is fitted into the connector 100 by moving the mating connector 500 downward in the −Z direction relative to the connector 100, a surface of the mating additional member 510 of the mating connector 500 slides along the slope 123a of the locking portion 123 to push the locking portion 123, whereby the extension portion 122 is displaced outward in the front-rear direction, which is the second direction of the connector 100, the extension portion 122 is then displaced inward in the front-rear direction, which is the second direction of the connector 100, and the locking portion 123 is fitted into the locking hole 511 of the mating additional member 510 to achieve a smoothly engaged state by the slope 123a of the locking portion 123. In addition, when the locking portion 123 is once fitted into the locking hole 511 of the mating additional member 510, the locking surface 123b on the lower side of the locking portion 123 faces an inner surface of the locking hole 155 of the mating additional member 510, and even when the mating connector 500 is moved in the direction (+Z direction) to be removed from the connector 100 in the state where the mating connector 500 is fitted into the connector 100, the locking surface 123b butts against the inner surface of the locking hole 511, and thus an upward movement of the mating connector 500 in the up-down direction, which is the third direction, is restricted. In other words, the locking surface 123b, which faces downward, which is one side of the up-down direction which is the third direction of the locking portion 123, restricts the movement of the mating connector 500 in the up-down direction which is the third direction and prevents it from being removed from the connector 100.

As shown in FIG. 16, the operating portion 124 is located between the spring portion 121 and the locking portion 123 in the left-right direction, which is the first direction of the extension portion 122, and is formed on the inner side of the connector 100 in the front-rear direction, which is the second direction of the extension portion 122. In addition, the operating portion 124 is formed so as to be movable between a non-release position that is located when no pressing operation is undergone and a release position that is located when a pressing operation is undergone toward the outer side of the connector 100 in the front-rear direction, which is the second direction, and that is located closer to the outer side of the connector 100 than the non-release position in the front-rear direction which is the second direction. Regarding the non-release position and the release position of the operating portion 124, as shown in FIG. 7, the on-release position means a state in which the locking portion 123 is fitted into the locking hole 511 of the mating additional member 510, and the release position means a state in which the locking portion 123 moves from the locking hole 511 of the mating additional member 510 to the left and right outer sides of the connector 100 and comes out of the locking hole 511 to release the engaged state.

As shown in FIG. 13 and the like, the operating portion 124 is formed including a sliding slope 124a on an upper side. The operating portion 124 undergoes a pressing operation by an unlocking jig 700 (to be described below) to broaden outward in the front-rear direction, which is the second direction, and the pressing operation is an operation in which a pressing leg portion 701 of the unlocking jig 700 is pressed from the upside position in the −Z direction, which is the downside direction, against the sliding slope 124a of the operating portion 124. In the pressing operation, the pressing leg portion 701 applies a pressing force while sliding along the surface of the sliding slope 124a of the operating portion 124, whereby since the operating portion 124 includes the sliding slope 124a, an operation error is extremely unlikely to occur in which the operating portion 124 is erroneously pressed down by the pressing leg portion 701, and the pressing leg portion 701 can smoothly move the operating portion 124 from the non-release position to the release position.

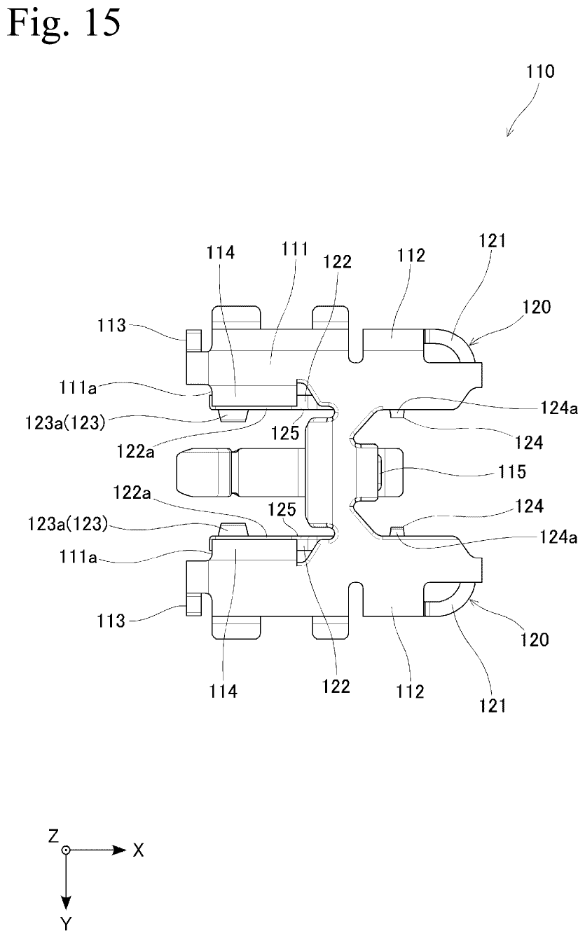

In the locking mechanism 120 of the present embodiment, the operating portion 124 is arranged on the side closer to the U-shaped spring portion 121, which functions as an elastic member, of the locking mechanism 120, that is, on a root side related to an elastic deformation of the locking mechanism 120 where the extension portion 122 is displaced, and since the locking portion 123 is arranged at a leading end, when the operating portion 124 undergoes the pressing operation to move from the non-release position to the release position, the locking portion 123, which moves in conjunction with the operating portion 124, moves with a larger amount of movement than the operating portion 124. In other words, the locking mechanism 120 of the present embodiment can set the amount of displacement of the operating portion 124 to be smaller than that of the related art while ensuring the necessary amount of displacement of the locking portion 123. Therefore, when the connector 100 is viewed in the third direction (up-down direction), the amount by which the non-release position of the operating portion 124 protrudes toward a side opposite to the release position in terms of the direction of movement, and the amount of dimension by which each of the operating portions 124 shown in the example in FIG. 15 in the present embodiment protrudes inward in the second direction (front-rear direction) from the top plate 111 to be described below, that is, the dimension by which the operating portion 124 is exposed from the top plate 111 in waiting to receive a pressing operation, can be set smaller than in the related art.

The additional member 110 of the present embodiment shown in FIGS. 13 to 20 further includes a top plate 111 and a bent portion 112.

The top plate 111 is a member formed in a position at which the spring portion 121 and the extension portion 122 are at least partially covered when viewed downward in the up-down direction which is the third direction, and formed to expand in parallel with the virtual plane formed by the left-right direction, which is the first direction, and the front-rear direction which is the second direction.

The bent portion 112 is a portion formed into a curved and bent shape to connect the end on the outer side of the connector 100 in the front-rear direction, which is the second direction, of the U-shape that constitutes the spring portion 121, and the top plate 111.

In other words, the locking mechanism 120 described above is formed in a manner that the end on the outer side of the spring portion 121 having the U-shape in the front-rear direction is connected to the lower end of the bent portion 112.

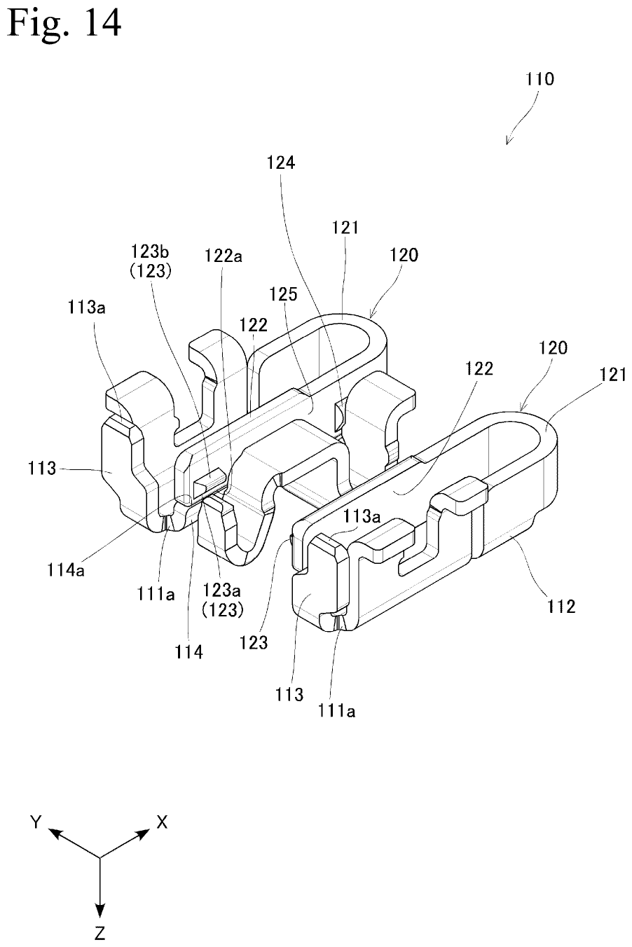

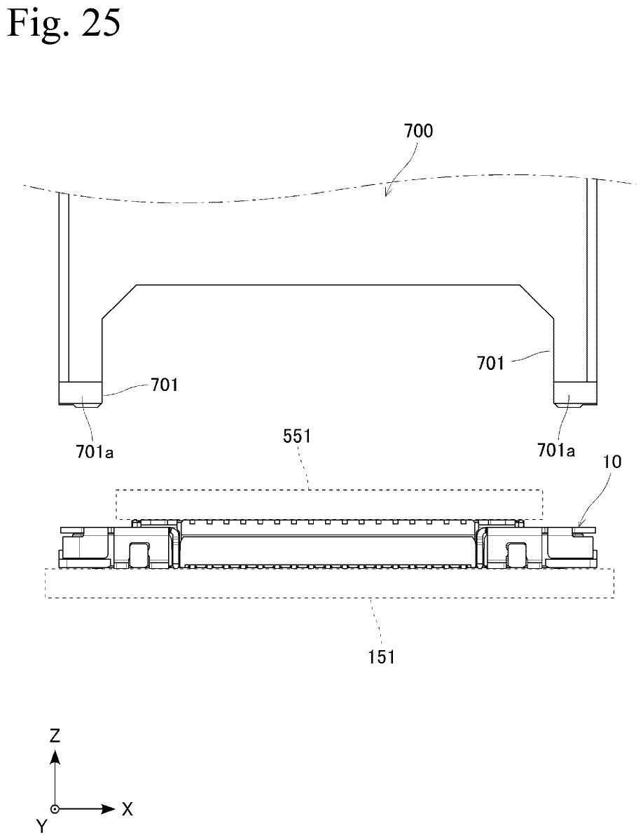

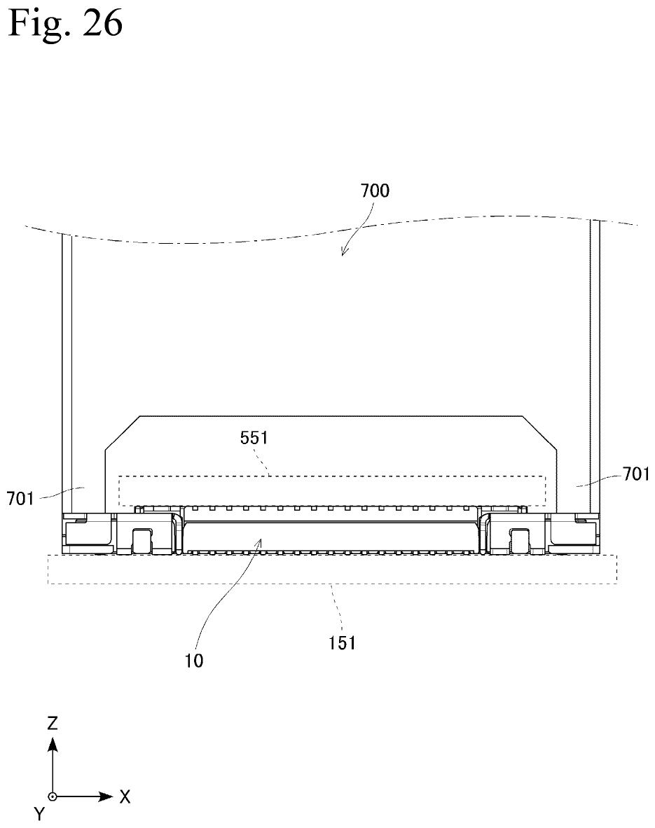

Furthermore, the additional member 110 of the present embodiment includes a hold-down 113. As shown in FIGS. 14, 17, and 20, the hold-down 113 is a portion that is formed continuously with an end 111a formed on the inner side of the connector 100 in the left-right direction, which is the first direction of the top plate 111, and is formed to extend from the end 111a in the −Z direction, which is the downside direction. The hold-down 113 includes a soldering portion 113a at a terminal end opposite to the connection portion with the end 111a, that is, at a downside end, and, for example, as shown in FIGS. 25 and 26, when the underside of the connector 100 is placed on a second circuit board 151, the soldering portion 113a can be soldered to the second circuit board 151. Due to the soldering of the soldering portion 113a of the hold-down 113 to the second circuit board 151, the additional member 110 including the locking mechanism 120 receiving an upward external force when a worker particularly attempts to remove the mating connector 500 is more firmly attached to the second circuit board 151.

Furthermore, the additional member 110 of the present embodiment includes a restriction portion 114. In this example, as shown in FIGS. 13 to 15, 18, and 20, the restriction portion 114 is formed as a portion extending from the top plate 111 toward the vicinity of the extension portion 122, and includes a restricting surface 114a facing downward in the up-down direction (third direction). That is, the restricting surface 114a is fixed to the top plate 111 and faces downward. On the other hand, regarding the extension portion 122, a surface of a portion of the extension portion 122 facing the restricting surface 114a is formed as a restricted surface 122a. Then, when the operating portion 124 is at the non-release position and no upward external force is being applied to the locking mechanism 120 including the extension portion 122, the restricting surface 114a and the restricted surface 122a face each other with a gap therebetween, and when an upward external force is applied to the extension portion 122, which is formed with the locking portion 123, to attempt to forcibly remove the mating connector 500 in a state where the locking portion 123 is fitted into the locking hole 511 of the mating connector 500, the restricted surface 122a butts against the restricting surface 114a. When the restricted surface 122a butts against the restricting surface 114a in this manner, irregular upward movement of the extension portion 122 is strongly restricted by the restriction portion 114. That is, the restriction portion 114 is formed such that the locking mechanism 120 acts more reliably. Since the additional member 110 of the present embodiment includes the restriction portion 114, breakage to the locking mechanism 120 due to the excessive operation can be suitably prevented.

The locking portion 123 and the restricted surface 122a formed on the extension portion 122 are preferably arranged such that positions thereof in the X direction (left-right direction), that is, the first direction on the extension portion 122 at least partially overlap (see FIG. 13 and the like). The locking portion 123, to which the upward force is applied, and the restricted surface 122a, to which the downward force is applied by butting against the restricting surface 114a are arranged in an overlapping position in the extension direction of the extension portion 122, that is, the X direction (first direction), whereby the occurrence of torque or bending stress in the extension portion 122 can be prevented, the restriction portion 114 can be effectively acted, and the occurrence of malfunctions such as breakage of the locking mechanism 120 can be suitably prevented.

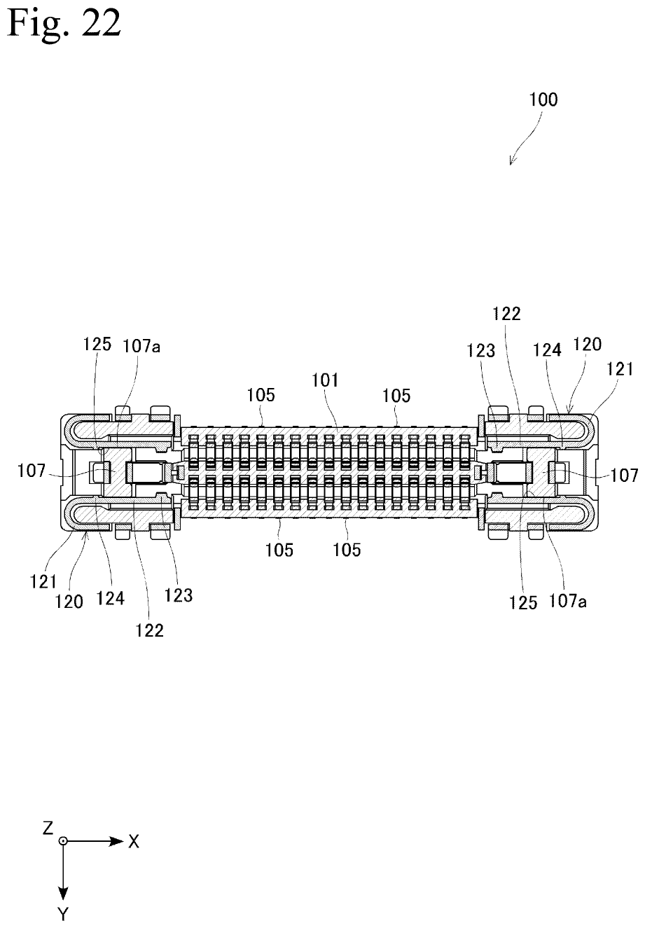

Furthermore, as shown in FIG. 16 and FIG. 22, which is a cross-sectional view of the connector 100 when viewed from above in the up-down direction, the pressing load receiving portion 125 provided in the locking mechanism 120 of the present embodiment is formed on the inner side of the connector 100 in the front-rear direction, which is the second direction of the extension portion 122, at a position between the locking portion 123 and the operating portion 124 in the left-right direction, which is the first direction of the extension portion 122. Then, as shown in FIGS. 12 and 22, the connector 100 of the present embodiment includes a total of four locking mechanisms 120 provided two by two on each of the two additional members 110. On the other hand, each of the two island portions 107 provided in the housing 101 includes a total of two pressing load portions 107a facing away from each other toward the outer side of the connector 100 in the front-rear direction which is the second direction. In other words, as is clear from a comparison of FIG. 12 with FIG. 22, in the connector 100 of the present embodiment, each of the total of four pressing load receiving portions 125 provided in the locking mechanism 120 is arranged opposite to any one corresponding pressing load portion 107a in the front-rear direction which is the second direction.

When the operating portion 124 is in the non-release position, each of the pressing load receiving portions 125 is configured to be in contact with the corresponding pressing load portion 107a and to receive a pressing load toward the outer side of the connector 100 in the front-rear direction which is the second direction (see the state in FIG. 22).

Here, the opening dimension in the natural state of the leading end of the U-shaped spring member including the spring portion 121 and the extension portion 122 is not controlled by press processing used in manufacturing the additional member 110, thereby having a variation. In other words, the position in the front-rear direction, which is the second direction, of the leading end of the extension portion 122 acting as a free end on a side farther from the spring portion 121 has a variation in a natural state where the extension portion 122 is not subjected to an external force. However, in the present invention, as described above, even when the operating portion 124 is in the non-release position, the spring member is not in the natural state, and the pressing load receiving portion 125 of the extension portion 122 is in contact with the pressing load portion 107a and receives a pressing load as an external force. In other words, even when the operating portion 124 is in the non-release position, the position of the extension portion 122 in the front-rear direction, which is the second direction, is determined by the pressing load portion 107a provided in the housing 101.

In other words, the connector 100 of the present embodiment is configured in which the pressing load portion 107a is provided in the housing 101, whereby the extension portion 122, which is elastically supported by the spring portion 121, is constantly pressed to apply a preload when the unlocking operation is not performed (that is, when the operating portion 124 is in the non-release position). Therefore, when the unlocking operation is not performed (that is, when the operating portion 124 is in the non-release position), since the positions of the locking portion 123 and the operating portion 124 are always defined at predetermined positions by the pressing load portion 107a provided in the housing 101, it is possible to eliminate the effects of variations in the opening dimension of the spring member (the U-shaped elastic member including the spring portion 121 and the extension portion 122) that inevitably occurs during manufacturing of the additional member 110.

On the other hand, when the operating portion 124 is in the release position, that is, when the operating portion 124 is operated to release the engagement of the locking portion 123 with the locking hole 511, each of the two pressing load receiving portions 125 being in contact with the two pressing load portions 107a of the island portion 107 moves toward the outer side of the connector 100 in the front-rear direction, which is the second direction, and separates from the corresponding pressing load portion 107a.

As described above, according to the present embodiment, it is possible to absorb the manufacturing variations in the opening dimension of the plate-like spring member having the U-shape (the elastic member), which is a component of the locking mechanism 120 responsible for holding and releasing the fitted state between the connector 100 and the mating connector 500, and in particular, it is possible to achieve the connector 100 in which the position of the locking portion 123 in the locked state is determined without variation, whereby it is possible to provide the connector 100 that can stably achieve the locked state, which is the fitted state of the connector 100 and the mating connector 500.

The description has been made above with respect to the detailed configuration of the total of four locking mechanisms 120 which are provided two by two for each of the two additional members 110 provided in the connector 100. Next, an operation will be described when the mating connector 500 is fitted into or removed from the connector 100.

When the mating connector 500 is fitted into the connector 100, the mating connector 500 moves in the −Z direction which is the downside direction, as shown in FIG. 8, to fit the mating connector 500 into the connector 100. At this time, since the mating connector 500 is pushed into the connector 100 while the surface of the mating additional member 510 slides along the slope 123a of the locking portion 123, the extension portion 122 is first displaced outward in the front-rear direction, which is the second direction of the connector 100, the extension portion 122 is then displaced to return inward in the front-rear direction, which is the second direction of the connector 100, and the locking portion 123 is fitted into the locking hole 511 of the additional member 510. By such an operation, the locking hole 511 and the locking portion 123 are engaged with each other, as shown in FIG. 7 to achieve a locked state in which the engagement between the mating connector 500 and the connector 100 is held.

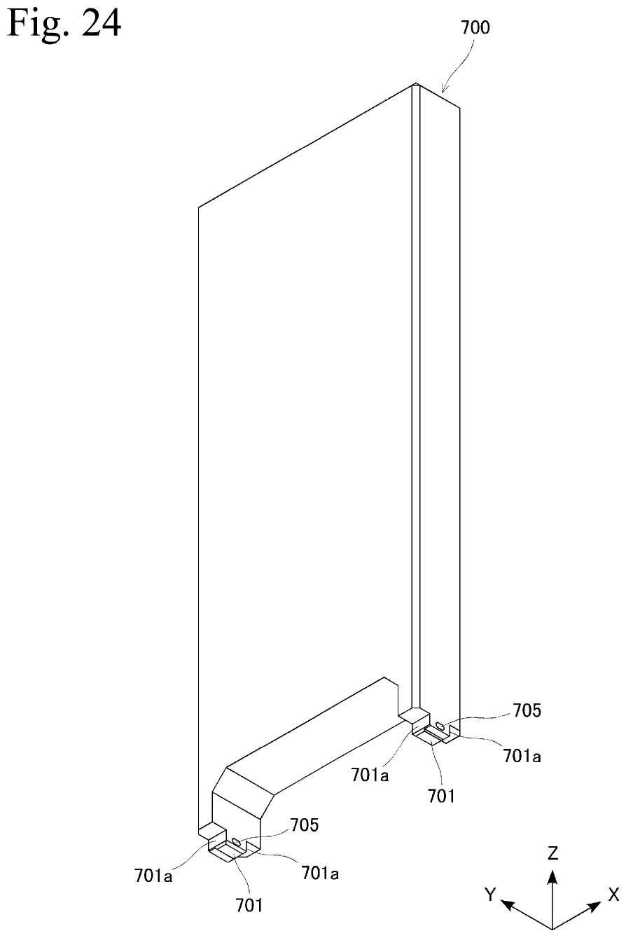

The locked state between the mating connector 500 and the connector 100 is released using the unlocking jig 700. The unlocking jig 700 of the present embodiment is shown in FIG. 24. That is, the total of four operating portions 124 can be simultaneously operated by the unlocking jig 700, the four operating portions being provided in the total of four locking mechanisms 120, respectively, which are provided two by two for each of the two additional members 110 provided in the connector 100.

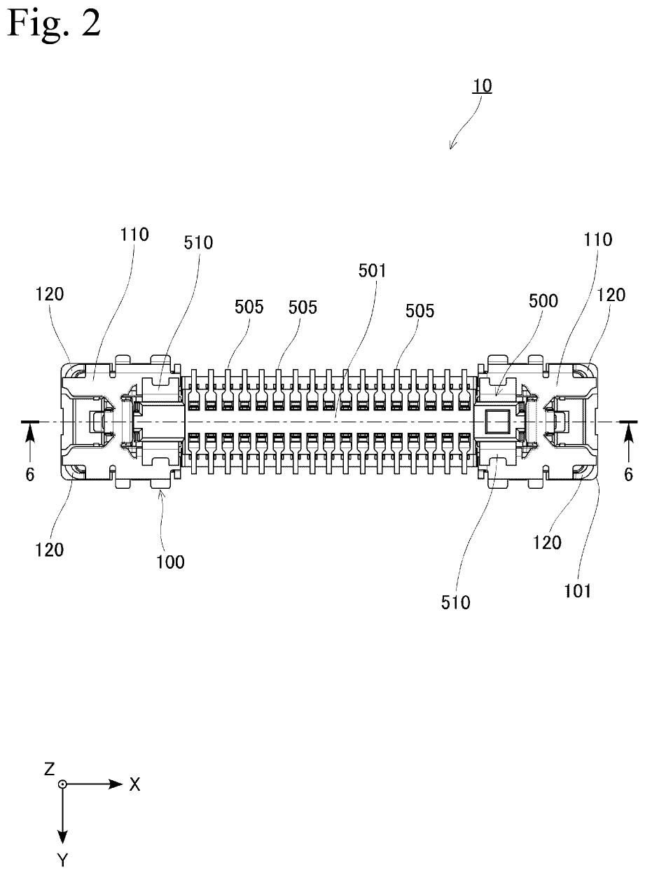

The unlocking jig 700 is a member including two pressing leg portions 701 that protrudes downward to lower left and right ends in the up-down direction (Z direction) of an elongated cubic member, as shown in FIG. 24, in a posture to be used with respect to the connector assembly 10 in which the connector 100 and the mating connector 500 are fitted into each other. Each of the pressing leg portions 701 includes a total of two pressing operation surfaces 701a facing outward on both sides in the front-rear direction (Y direction). That is, the unlocking jig 700 includes a total of four pressing operation surfaces 701a. The unlocking jig 700 moves in the −Z direction, which is the downside direction, from the upside position of the connector assembly 10 being in a state where the mating connector 500 is fitted into the connector 100, so as to change from a state shown in FIG. 25 to a state shown in FIG. 26. As shown in FIGS. 1 and 2, the connector assembly 10 has a space in which a gap between the two locking mechanisms 120 is open upward which are provided on each of the additional members 110 to face each other in the front-rear direction in the state where the connector 100 and the mating connector 500 are fitted into each other. The two pressing leg portions 701 of the unlocking jig 700 are simultaneously inserted from above into each of the two spaces, which are open upward, on both sides in the left-right direction of the connector assembly 10 being in the fitted state. At this time, the amount of protrusion of the operating portion 124 protruding into each of the spaces, more specifically, the dimension of the operating portion 124 that is exposed inward in the Y direction (front-rear direction) from the top plate 111 when viewed from above in the Z direction is significantly smaller than that of the related art (see FIG. 15). When the unlocking jig 700 is pressed against such a connector assembly 10 in the −Z direction, which is the downside direction, as shown in FIG. 26, the total of four pressing operation surfaces 701a provided two by two on each of the two pressing leg portions 701 of the unlocking jig 700 press the total of four operating portions 124 provided one by one in each of the locking mechanisms 120 of the connector 100 to broaden outward in the front-rear direction, which is the second direction, and move each of the operating portions from the non-release position to the release position. Thus, the extension portion 122 moves outward in the front-rear direction, which is the second direction, to open with the U-shaped spring portion 121 as a fulcrum, whereby the locking portion 123 farther from the fulcrum along the extension portion 122 than the operating portion 124 moves in conjunction with the operating portion 124 in the same direction as the movement of the operating portion 124, and moves with a larger amount of movement than the operating portion 124 that moves from non-release position to the release position. In a state of starting such an operation, that is, in a state where the connector assembly 10 is waiting for the insertion of the unlocking jig 700, the dimension of the operating portion 124 exposed from the top plate 111 is smaller as described above, and thus an operation error is extremely unlikely to occur in which the operating portion 124 or the extension portion 122 is erroneously pressed down by the pressing leg portion 701. Furthermore, as shown in FIGS. 13 and 15, since the exposed portion of the operating portion 124, which is exposed in a small dimension from the top plate 111, is the sliding slope 124a, when the pressing leg portion 701 of the unlocking jig 700 is pressed against the sliding slope 124a in the −Z direction, which is the downside direction, from the upside direction, the pressing leg portion 701 slides along the surface of the sliding slope 124a and presses the operating portion 124 to broaden outward in the front-rear direction, which is the second direction, whereby the pressing leg portion 701 can smoothly move the operating portion 124 from the non-release position to the release position. In the present embodiment, when the unlocking operation is not performed (that is, when the operating portion 124 is in the non-release position), since the positions of the locking portion 123 and the operating portion 124 are always defined at predetermined positions by the pressing load portion 107a provided in the housing 101, the sliding slope 124a is also always exposed with the same amount of protrusion from the top plate 111, and can always stably undergo the pressing operation from the pressing leg portion 701 of the unlocking jig 700. Furthermore, the amount of operation (amount of movement) required to move the operating portion 124 to the non-release position is small, and thus the operability of unlocking is improved and lighter compared to the related art. As the locking portion 123 described above moves, the engagement of the locking portion 123 fitted into the locking hole 511 of the mating additional member 510 is released, that is, the locking surface 123b no longer contacts with or faces the inner surface of the locking hole 511 in the up-down direction, and the locking portion 123 is open at the upper part, making it possible to move upward. From the state where the engagement between the locking hole 511 and the locking portion 123 is released, that is, the state shown in FIG. 26, the operator can lift the mating connector 500 in the +Z direction, which is the upside direction, and can remove the mating connector 500 from the connector 100.

Here, before the pressing operation surface 701a of the unlocking jig 700 presses the operating portion 124, that is, in a state of waiting for the insertion of the unlocking jig 700, the pressing load receiving portion 125 comes into contact with the pressing load portion 107a and receives a pressure load, whereby the position of the operating portion 124 is always defined at a predetermined position, and thus the unlocking operation of the locking mechanism 120 can always be executed stably by the unlocking jig 700.

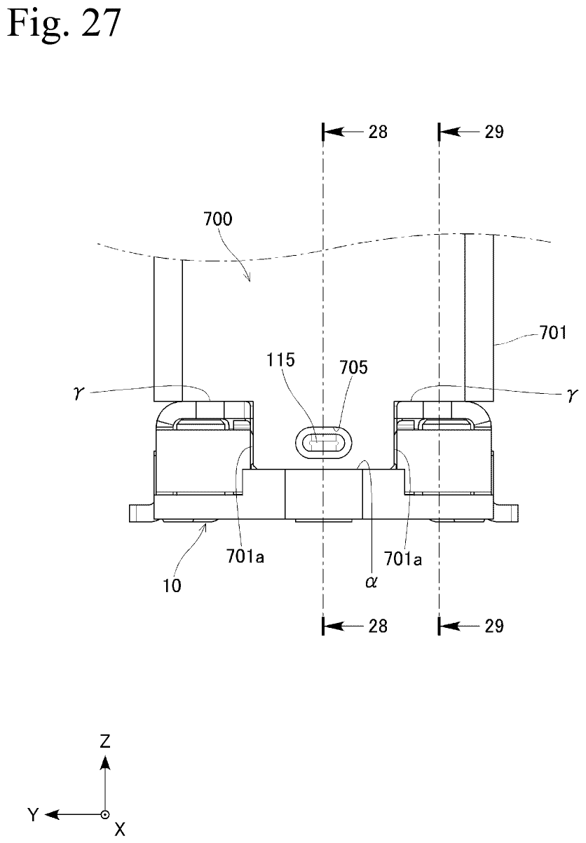

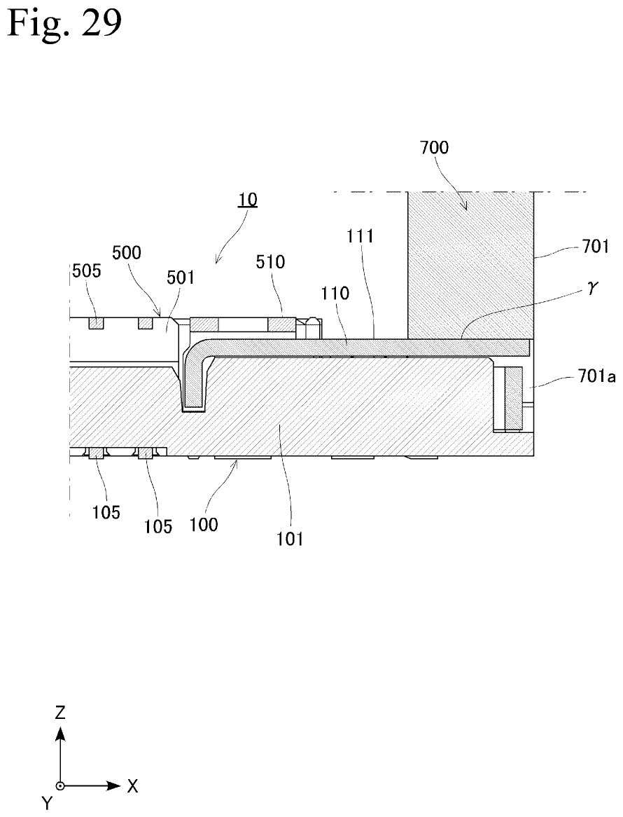

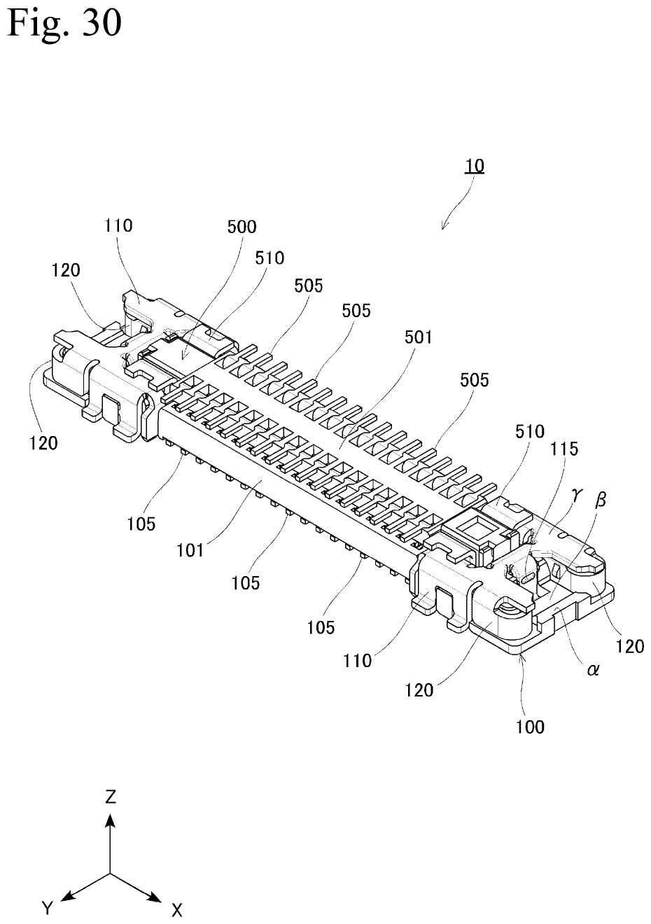

In the present embodiment, as shown in FIGS. 27 to 30, when the operating portion 124 is pressed by the unlocking jig 700 and the operating portion 124 moves from the non-release position to the release position, the connector 100 and the unlocking jig 700 of the present embodiment are configured to form three contact surfaces α, β, and γ therebetween. In this way, a plurality of contact surfaces α, β, and γ between the connector 100, which receives a pressing force in the −Z direction being the downside direction from the unlocking jig 700, and the unlocking jig 700 are provided, whereby the posture of the unlocking jig 700 in contact with the connector 100 can be stabilized, and thus malfunctions such as twisting of the unlocking jig 700 can be suitably prevented.

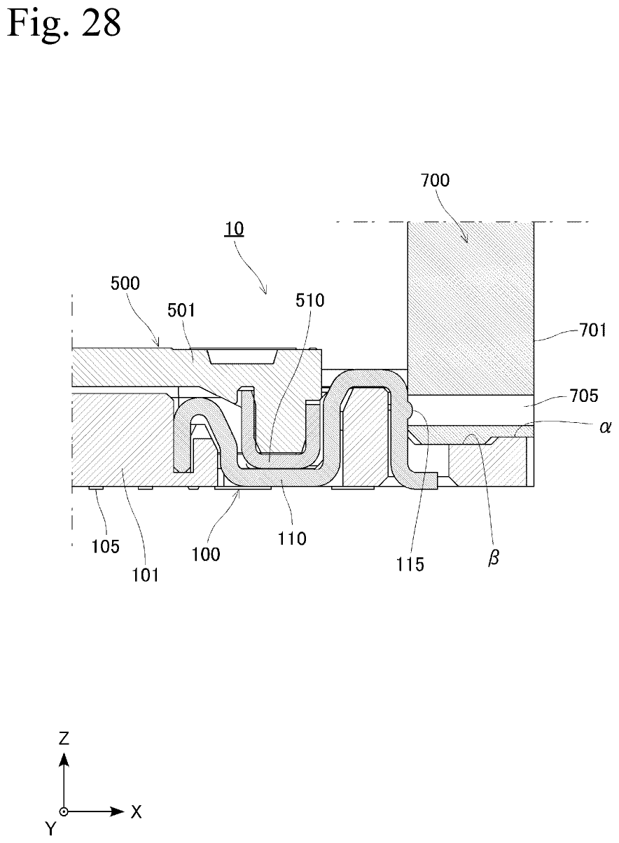

In the present embodiment, as shown in FIGS. 27 and 28, a connector-side operation feeling imparting portion 115 formed as a protrusion portion can be provided in the additional member 110, and a jig-side operation feeling imparting portion 705 formed as a corresponding recess portion (in this example, a through hole) can be provided in the unlocking jig 700. Then, as shown in FIGS. 27 and 28, the connector-side operation feeling imparting portion 115 and the jig-side operation feeling imparting portion 705 of the unlocking jig 700 are preferably formed with dimensions and shapes having an amount of play when fitted with each other. With such a configuration, during the operating portion 124 is operated by the unlocking jig 700 and the operating portion 124 moves from the non-release position to the release position, when the connector-side operation feeling imparting portion 115 and the jig-side operation feeling imparting portion 705 are fitted with each other, operation feeling (click feeling) can be imparted to the operator who operates the unlocking jig 700.

When being used with the connector assembly 10 as shown in FIG. 26, the unlocking jig 700 of the present embodiment has preferably an outline shape that does not deviates from the outer shape of the connector assembly 10 when viewed in the up-down direction which is the third direction. The outline shape of the unlocking jig 700 is formed with dimensions so as not to deviate from the outer shape of the connector assembly 10, whereby interference with other components installed on the board can be avoided to contribute to improving the operability, for example.

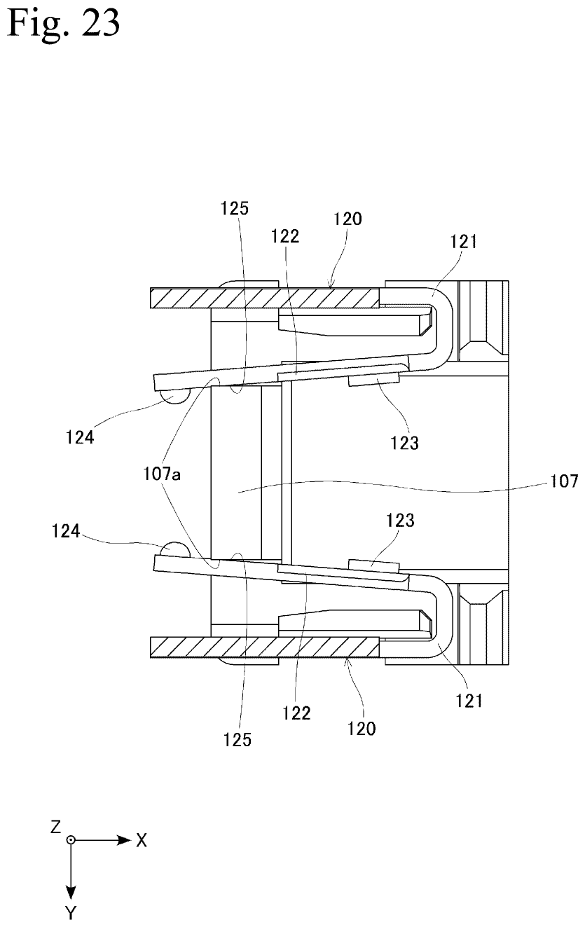

In the embodiment described above, as shown in FIG. 22 and the like, the spring portion 121 is provided at the outer position in the first direction (left-right direction) of each of the locking mechanisms 120, and has the U-shape that is closed at the outer side of the connector 100 and open at the inner side thereof in the first direction when viewed in the third direction (up-down direction). However, the present invention is not limited thereto, and as in the modified example shown in FIG. 23 (FIG. 23 showing the locking mechanism 120 of the additional member 110 installed on the left side of the connector 100), the direction of the spring portion 121 is reversed in the first direction (left-right direction) and may also be located at the inner position in the first direction (left-right direction) of each of the locking mechanisms 120. In other words, in this modified example, when viewed in the third direction (up-down direction), each of the spring portions 121 has the U-shape that is closed at the inner side of the connector 100 and open at the outer side thereof in the left-right direction, which is the first direction, but this modified example is the same as the embodiment shown in FIG. 22 and the like in that the operating portion 124 is arranged on the outer side in the first direction (left-right direction) of the extension portion 122, the locking portion 123 is arranged on the inner side thereof, and the pressing load receiving portion 125 is arranged between the operating portion 124 and the locking portion 123. In this modified example, as shown in FIG. 23, since the operating portion 124 is particularly located at the leading end on the opening side of the spring member having the U-shape, the position of the operating portion 124 is stably defined more effectively. Therefore, according to this modified example, the unlocking operation of the locking mechanism 120 can be always stably executed by the unlocking jig 700, in particular.

Although the preferred embodiment of the present invention has been described above, the technical scope of the present invention is not limited to the scope described in the above-described embodiment. The above-described embodiment can be variously modified and improved.

For example, the connector assembly 10 configured by the mating connector 500 and the connector 100 of the above-described embodiment is particularly useful when being used as a board-to-board connector that electrically connects a first circuit board 551 on which the mating connector 500 is mounted and a second circuit board 151 on which the connector 100 is mounted, as shown in FIGS. 25 and 26.

For example, in the above-described embodiment, a configuration has been adopted in which the mating connector 500 is configured as a plug connector, the connector 100 is configured as a receptacle connector, and the locking mechanism 120 is provided for the connector 100. However, the connector may be either a plug connector or a receptacle connector in the range in which the locking mechanism according to the present invention exerts the same effects as those of the above-described embodiment. In the present invention, the mating connector and the connector include all types of connectors.

It will be apparent from the claims that such modified or improved forms may also be included within the technical scope of the present invention.

### REFERENCE SIGNS LIST

10 connector assembly
100 connector
101 housing
103 terminal holding portion
105 plurality of terminals
107 island portion
107a pressing load portion
110 additional member
111 top plate
111a end
112 bent portion
113 hold-down
113a soldering portion
114 restriction portion
114a restricting surface
115 connector-side operation feeling imparting portion (protrusion portion)
120 locking mechanism
121 spring portion
122 extension portion
122a restricted surface
123 locking portion
123a slope
123b locking surface
124 operating portion
124a sliding slope
125 pressing load receiving portion
151 second circuit board (board)
500 mating connector
501 mating housing
503 mating terminal holding portion
505 plurality of mating terminals
510 mating additional member
511 locking hole
551 first circuit board (board)
700 unlocking jig
701 pressing leg portion
701a pressing operation surface
705 jig-side operation feeling imparting portion (recess portion)
α, β, γ contact surface (with unlocking jig)

1. A connector that, by moving a mating connector in a third direction orthogonal to a virtual plane formed by a first direction and a second direction that are orthogonal to each other, is fitted with or removed from the mating connector, the connector- comprising:
a housing, including
a terminal holding portion, and
two island portions, each of the two island portions having two pressing load portions facing away from each other toward an outer side of the connector in the second direction;
a plurality of terminals held in the terminal holding portion and arranged in the first direction in the housing;
two additional members held in the housing and located at both ends of the housing in the first direction, each of the two additional members including
two locking mechanisms located to face each other in the second direction, each of the two locking mechanisms including
a spring portion being a plate elastic member having an U-shape that is closed on one side of the outer side or an inner side of the connector and open on the other side of the outer side or the inner side thereof in the first direction when viewed in the third direction, an end of the U-shape on the outer side of the connector in the second direction being formed as a fixed end, an end of the U-shape on the inner side of the connector in the second direction being formed as a free end,
an extension portion formed to be continuous with the end on the inner side of the connector in the second direction, which is formed as the free end of the spring portion having the U-shape, and to extend in the first direction, the extension portion being displaced in the second direction by an elastic force of the spring portion,
a locking portion formed on the inner side of the connector in the second direction of the extension portion, and including a locking surface that faces one side in the third direction,
an operating portion formed on the outer side of the connector than the locking portion in the first direction of the extension portion, and on the inner side of the connector in the second direction of the extension portion, and
a pressing load receiving portion provided on the inner side of the connector in the second direction of the extension portion, at a position between the locking portion and the operating portion in the first direction of the extension portion, the pressing load receiving portion facing a corresponding one of the two pressing load portions in the second direction,
wherein the operating portion moves between a non-release position, and a release position that, when a pressing operation toward the outer side of the connector in the second direction is undergone, is located closer to the outer side of the connector than the non-release position in the second direction,
when the operating portion is in the non-release position, the pressing load receiving portion comes into contact with the corresponding one of the two pressing load portions, and receives a pressing load toward the outer side of the connector in the second direction, and
when the operating portion is in the release position, the pressing load receiving portion separates from the corresponding one of the two pressing load portions.
